(19) United States
(12) Patent Application Publication
(10) Pub. No.: US 2017/0262905 A1
(43) Pub. Date: Sep. 14, 2017

(54) COMPUTER-READABLE RECORDING MEDIUM, DATA ACCUMULATION DETERMINATION METHOD, AND DATA ACCUMULATION DETERMINATION APPARATUS

(71) Applicant: FUJITSU LIMITED, Kawasaki-shi (JP)

(72) Inventors: Miho MURATA, Kawasaki (JP); Hidekazu TAKAHASHI, Kawasaki (JP); Nobutaka IMAMURA, Yokohama (JP)

(73) Assignee: FUJITSU LIMITED, Kawasaki-shi (JP)

(21) Appl. No.: 15/451,751

(22) Filed: Mar. 7, 2017

(30) Foreign Application Priority Data
Mar. 11, 2016 (JP) 2016-048082

(51) Int. Cl. G06Q 30/02; G06N 99/00

(52) U.S. Cl. CPC G06Q 30/0283; G06N 99/005

(57) ABSTRACT

A computer-readable recording medium storing a data accumulation determination program is disclosed. A first cost and a second cost are calculated from a process content pertinent to a process for acquiring a final result by a plurality of processes. The process content includes a plurality of process contents respective to a plurality sets of output data generated in paths until the final result is acquired by the plurality of processes from subject data. The first cost corresponds to a cost for accumulating the output data in a repository. The second cost corresponds to a cost for generating the output data that are not accumulated in the repository. An accumulation necessity is determined for each of the plurality of sets of the output data based on the first cost and the second cost.

### CROSS-REFERENCE TO RELATED APPLICATIONS

This application is based upon and claims the benefit of priority of the prior Japanese Patent Application No. 2016-048082, filed on Mar. 11, 2016, the entire contents of which are incorporated herein by reference.

### FIELD

The embodiments discussed herein are related to a computer-readable storage medium storing therein a data accumulation determination program, a data accumulation determination method, and a data accumulation determination apparatus.

### BACKGROUND

Recently, in order to extract and use valuable information for a business from a large amount of data (called “big data”) generated and accumulated in various situations, high level analysis technologies such as a machine learning and the like have been frequently used. This machine learning uses a large capacity of a storage area to repeat data processing.

A technology related to large-scale data has been presented, in which feedback information with respect to data generated and stored in a middle stage of the analysis are quantified and received as an evaluation value, and data, to which the evaluation value is not given, are preferentially deleted.

### PATENT DOCUMENTS

Japanese Laid-open Patent Publication No. 2011-002911

Japanese Laid-open Patent Publication No. 2014-174728

### SUMMARY

According to one aspect of the embodiments, there is provided a non-transitory computer-readable recording medium storing therein a data accumulation determining program that causes a computer to execute a process including: calculating a first cost and a second cost from a process content pertinent to a process for acquiring a final result by a plurality of processes, the process content including a plurality of process contents respective to a plurality of sets of the output data generated in paths until the final result is acquired by the plurality of processes from subject data, the first cost corresponding to a cost for accumulating the output data in a repository, the second cost corresponding to a cost for generating the output data that are not accumulated in the repository; and determining an accumulation necessity for each of the plurality of sets of the output data based on the first cost and the second cost.

According to another aspect of the embodiment, there may be provided a data accumulation determination method, a data accumulation determination apparatus, or a data accumulation determination program therefor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a process for generating and evaluating one model;

FIG. 2 is a diagram for explaining an example of a successive feature extraction process using a genetic algorithm;

FIG. 3 is a diagram for briefly explaining an accumulation necessity determination process;

FIG. 4 is a diagram for explaining an example of a case in which the accumulation necessity determination process is not conducted;

FIG. 5 is a diagram illustrating an example of a functional configuration of an information processing apparatus;

FIG. 6 is a diagram illustrating a hardware configuration of the information processing apparatus;

FIG. 7A and FIG. 7B are flowcharts for explaining a first example of the accumulation necessity determination process;

FIG. 8A, FIG. 8B, and FIG. 8C are diagrams for explaining a method for generating a process content in step S402 in FIG. 7A;

FIG. 9A through FIG. 9D are diagrams for explaining a method for calculating a use expectation value in step S408 in FIG. 7B;

FIG. 10 is a diagram for explaining a cost calculation in step S409 and the accumulation necessity determination process in step S410 in FIG. 7B;

FIG. 11 is a diagram illustrating a first data example of a meta information table;

FIG. 12 is a diagram illustrating a second data example of the meta information table;

FIG. 13A through FIG. 13C are diagrams for explaining a second example of the accumulation necessity determination process;

FIG. 14 is a diagram illustrating a data example of a symbol table;

FIG. 15 is a diagram illustrating a data transition in the meta information table;

FIG. 16 is a flowchart for explaining a third example of the accumulation necessity determination process;

FIG. 17 is a diagram illustrating a data example of a symbol table in a case of third timing; and

FIG. 18 is a diagram illustrating a data transition example of the meta information table.

### DESCRIPTION OF EMBODIMENTS

In the above described technology related to large-scale data, since data, to which an evaluation value is not given, are preferentially deleted, data actually having a low utility value are being retained in subsequent processes.

Accordingly, an embodiment described below will present a computer-readable storage medium storing therein a data accumulation determination program, a data accumulation determination method, and a data accumulation determination apparatus, to accumulate data having high reuse efficiency in data processing formed by multiple processes, in which an output result of one process is used in another process.

In the following, a preferred embodiment will be described with reference to the accompanying drawings. In an analysis by machine learning, a model is generated for a prior prediction and a prior classification, and actual data are applied to the generated model. Then, an analysis result is acquired.

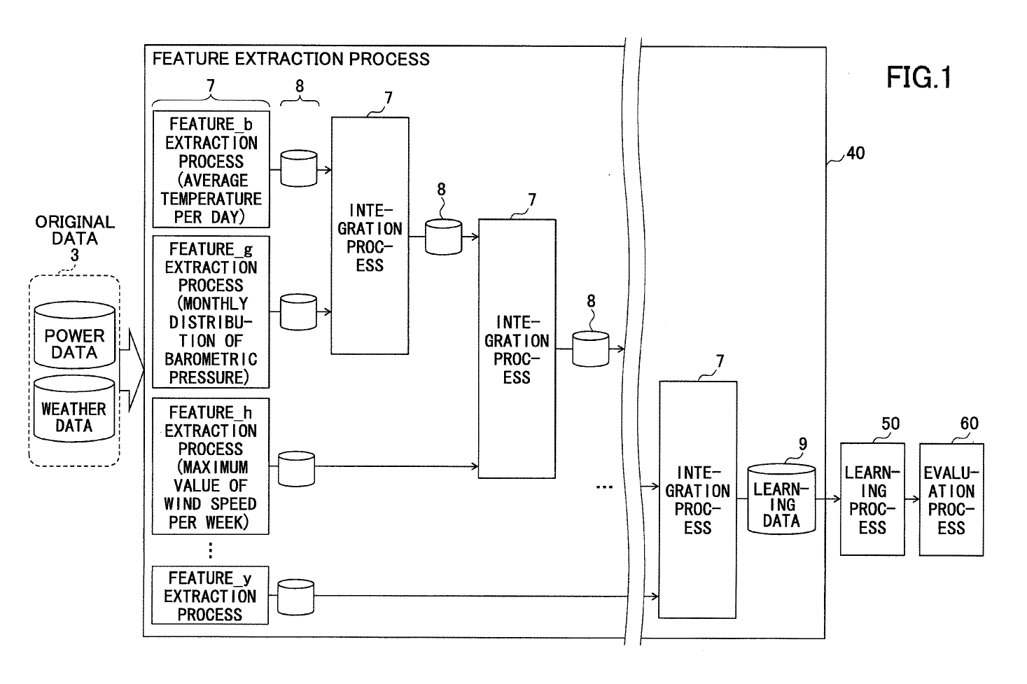

In order to generate an optimum model, a feature extraction process, a learning process, and an evaluation process are generally repeated until accuracy of the model becomes improved. The feature extraction process generates learning data by extracting feature data from original data. The learning process generates the model. The evaluation process evaluates the generated model. A process to be repeated will be described with reference to FIG. 1.

FIG. 1 is a diagram for explaining the process for generating and evaluating one model. In FIG. 1, the process to be repeated is conducted by a feature extraction process 40, a learning process 50, and an evaluation process 60, as described above.

The feature extraction process 40 extracts learning data 9, which are effective to predict and classify from original data 3, that is, indicate feature information. The learning process 50 learns the model from the learning data 9 acquired by the feature extraction process 40. The evaluation process 60 applies evaluation data to the model generated by the learning process 50, and evaluates the accuracy of the model.

The feature extraction process 40 extracts feature information acquired by using various values of the original data 3. The feature information is effective to use for prediction and classification. The feature information corresponds to the learning data 9.

Generally, an analyst extracts feature data by using the various values of the original data 3 based on his/her experience. However, recently, a number of features (a number of dimensions of target data) extracted from the original data 3 have increased. Hence, it becomes difficult to extract features in a manual operation.

Consequently, a feature extraction method may be considered in that various sets of the learning data 9 are generated by extracting various features, and useful features are finally specified by learning all sets of the various sets of the learning data 9. However, a longer time may be spent for the feature extraction process 40. In a case of a large amount of the features, it is difficult to extract all the features and learn and evaluate all the extracted features.

Hence, a successive feature extraction method has been presented. This method repeats to extract a small amount of features from all feature candidates, and to learn and evaluate the extracted features. As a method for determining which features are extracted for each trial (each of repetitions of the feature extraction process 40, the learning process 50, and the evaluation process 60), a genetic algorithm (GA) is known.

In the successive feature extraction method, features, which indicate a good evaluation result, tend to be retained. In the feature extraction by multiple trials, the same features are extracted multiple times. That is, a process, which spends much time, is performed multiple times.

However, the feature extraction process 40 is mostly formed by a plurality of processes 7 including a feature extraction process from the original data 3, an integration process, and the like. Thus, in general, output data 8 of a certain process 7 are temporarily stored, and are input to a next process 7.

For example, in a case of generating the learning data 9 from the original data 3 including power data, weather data, and the like, as the various processes 7, a feature_b extraction process, a feature_g extraction process, a feature_h extraction process, . . . , a feature_y extraction process, and one or more integration processes are performed.

In the feature_b extraction process, an average temperature per day is calculated. In the feature_g extraction process, a monthly distribution of a barometric pressure is calculated. In the feature_h extraction process, a maximum value of a wind speed per week is calculated. These processes are performed at an initial process stage using values (raw data) acquired from the original data 3. In the integration processes, two or more sets of the output data 8 acquired at the initial process stage are integrated, two or more set of data including the output data 8 acquired at the initial process stage and the output data 8 acquired after one integration process are integrated, two or more sets of the output data 8 acquired after the integration processes are integrated, or the like.

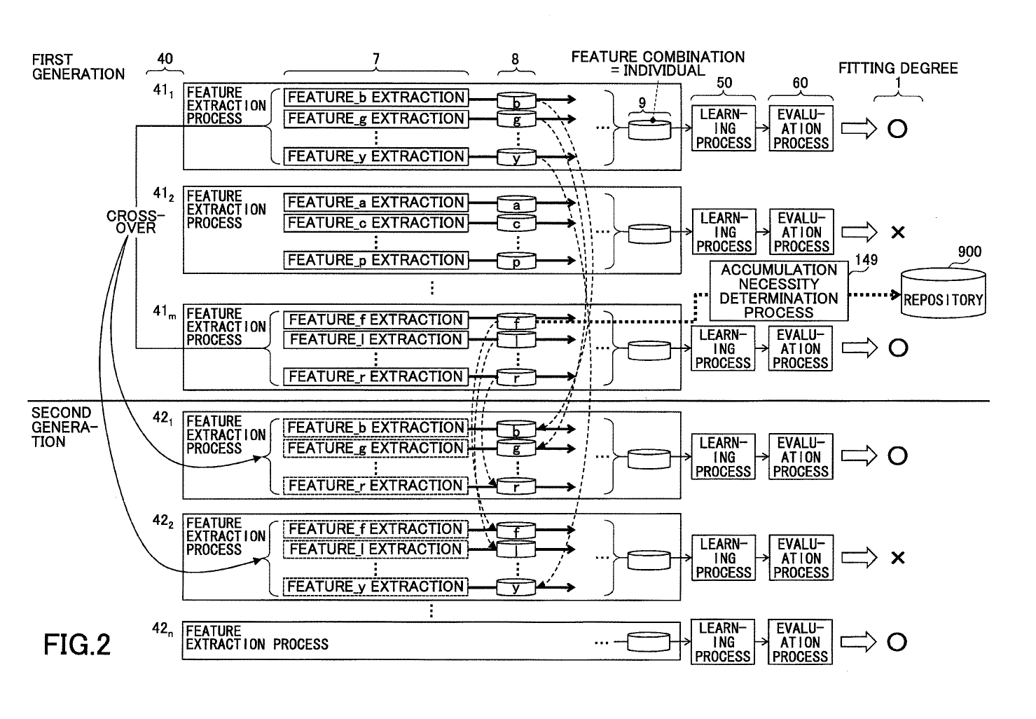

A formation of the processes 7 in the feature extraction process 40 is changed, and the feature extraction process 40 is repeated multiple times. That is, if the output data 8 of a repetitive process are reused, the same process taking time is not repeated. Thus, it is possible to greatly reduce an entire process time pertinent to the machine learning. The output data 8 corresponds to intermediate data in the feature extraction process 40. An example of the feature extraction process 40, which is successively conducted and uses the genetic algorithm, will be depicted in FIG. 2.

FIG. 2 is a diagram for explaining the example of the successive feature extraction process using the genetic algorithm. In FIG. 2, the example of the feature extraction process in a first generation and a second generation is illustrated.

In the first generation, the learning process 50 generates a model by using the learning data 9 acquired from each of feature extraction processes 41₁, 41₂, . . . , 41ₘ (collectively called “feature extraction processes 40”) for extracting combinations of different features, and the evaluation process 60 evaluates the model.

The evaluation process 60 evaluates how much the model generated by the learning process 50 predicts or classifies a certain matter from new evaluation data. In the successive feature extraction process using the genetic algorithm, this evaluation result is applied as a fitting degree in the genetic algorithm. For example, a mark “o” or a mark “x” indicates whether each of individuals (each of feature combinations) is suitable for a target prediction. The mark “o” indicates that prediction accuracy is greater than or equal to a threshold. The mark “x” indicates that the prediction accuracy is less than the threshold and the learning data 9 suitable for the prediction is not acquired.

In the first generation, by a plurality of feature extraction processes 40, the features are randomly combined within a predetermined range of the combinations.

The features, which are extracted and combined for the learning data 9 and to which the fitting degree indicates “x”, are rarely applied for the following feature extraction process 40. In this example in the first generation, a combination of a feature a, a feature c, . . . , and a feature p, which are extracted in the feature extraction process 41₂ having the fitting degree “x”, is rarely applied in the second and later generations.

In this example, a combination of a feature_b, a feature_g, . . . , and a feature_y in the feature extraction process 41₁, and a combination of a feature_f, a feature_l, . . . , and a feature_r in the feature extraction process 41ₘ in the first generation are applied in the second generation.

In the second generation, instead of combining the same features in the first generation, features are crossed over among the combinations in the first generation. That is, two combinations are selected among multiple combinations having the fitting degree “o” by a possibility depending on the prediction accuracy, and the features are mutually replaced by each other between two selected features.

In detail, the feature_y and the feature_r are replaced by each other between the feature combination (b, g, . . . , y) of the feature extraction process 41₁ and the feature combination (f, l, . . . , r) of the feature extraction process 41ₘ. Accordingly, in the feature extraction process 41₁, data indicating the features acquired by the combination (b, g, . . . , r) and conducting the various processes are regarded as the learning data 9.

Also, in a feature extraction process 42₂, the features are extracted by the combination (f, 1, . . . , y), the various processes 7 are conducted, and the learning data 9 are acquired. As described above, the features are crossed over among one or more combinations, and the feature extraction process 42₁ through 42₂.

Similar to the first generation, in the second generation, the combination of the features, to which the fitting degree “x” is given, is rarely applied in a next three generations. However, after the second generation, the features, which have not been extracted from the original data 3, are extracted, and form a new combination to perform the machine learning.

As described above, the learning process 50 is conducted with the learning data 9, which are acquired by changing the combinations of the features initially extracted from the original data 3, and the evaluation process 60 repetitively evaluates the learning data 9. Hence, it is possible to acquire optimal feature combinations to realize high prediction accuracy.

However, among the various processes 7 in each of the plurality of feature extraction processes 40, the same process 7 performed in a previous generation may be included. In this case, previous output data 8 may be reused.

In the embodiment, based on a use expectation value for the output data 8 to be reused in future, an execution time of a process until the output data 8 are generated, and a reuse time to reuse the output data 8, a cost in a case in which the output data 8 are accumulated in a repository 900 and another cost in which the output data 8 are not accumulated in the repository 900 are calculated. Based on a calculation result, it is determined whether the output data 8 acquired in the process 7 are accumulated in the repository 900.

When the output data 8 have been accumulated in the repository 900 by the process 7 before the same process 7 is executed, an execution of the same process 7 is suppressed. When the output data 8 to be acquired from the process 7 have not been accumulated in repository 900, the process 7 is executed. When the cost in the case in which the output data 8 are accumulated in the repository 900 and the cost in the case in which the output data 8 are not accumulated satisfy a condition, the output data 8 are accumulated in the repository 900. When the above described two costs do not satisfy the condition, the process 7 is executed. However, the output data 8 acquired as a result of the execution are not accumulated in the repository 900.

In the embodiment, based on the use expectation value for the output data 8 to reuse in future, the execution time of a process until the output data 8 are generated, and the reuse time to reuse the output data 8, an accumulation necessity is determined. Accordingly, it is possible to suppress increase of an accumulation amount of the output data 8 being generated during the machine learning. It is possible to reduce a storage capacity demanded for the repository 900.

In an example in FIG. 2, when the process 7 is executed, an accumulation necessity determination process 149 is conducted to determine the accumulation necessity of the output data 8 acquired by the process 7. The output data 8, which the accumulation necessity determination process 149 determines to accumulate, are stored in the repository 900. However, other data are not accumulated in the repository 900.

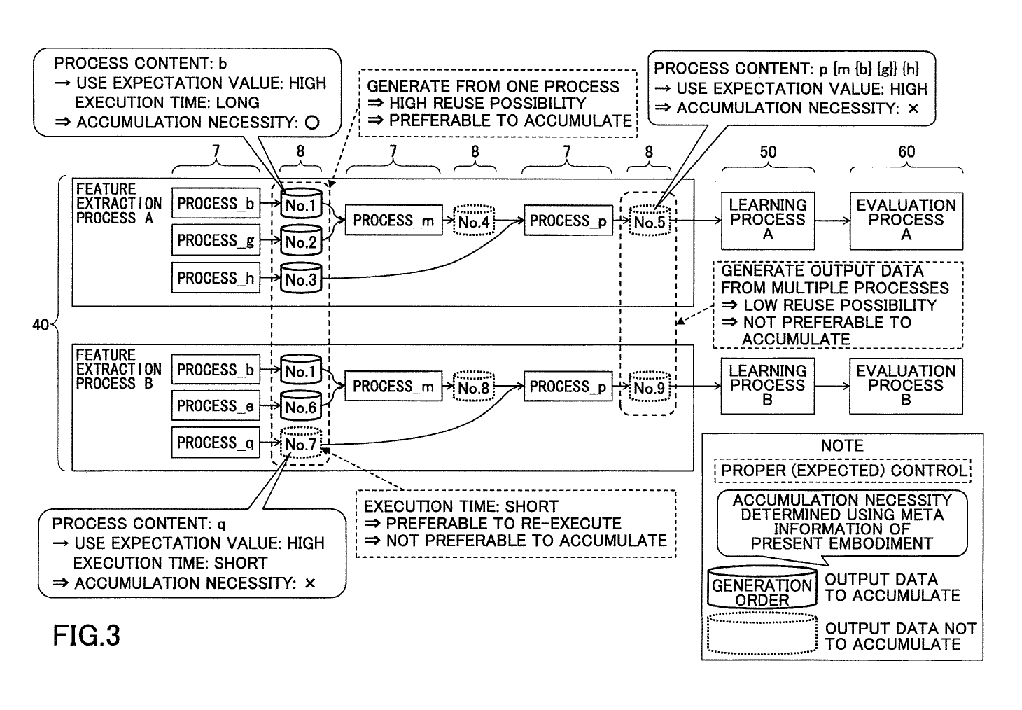

FIG. 3 is a diagram for briefly explaining the accumulation necessity determination process in the embodiment. In FIG. 3, as the feature extraction process 40, the feature extraction process A and the feature extraction process B are depicted. For the feature extraction process A, a process_b, a process_g, a process_m, and a process_p are depicted as the various processes 7. For the feature extraction process B, the process_b, a process_e, a process_q, the process_m, and the process_p are depicted as the various processes 7. The same process names represent that the same process programs are used. However, when input data are different even for the same process name, the output data 8 acquired in the process are different. Also, regardless of generations, the feature extraction process B is conducted after the feature extraction process A.

Also, as the learning process 50 and the evaluation process 60, a learning process A and an evaluation process A are associated with the feature extraction A, and a learning process B and an evaluation process B are associated with the feature extraction process B.

Furthermore, a generation order example is indicated in a symbol for each set of the output data 8. By the accumulation necessity determination process 149 in the embodiment, the output data 8 to be accumulated in the repository 900 are represented by a solid line, and the output data 8 not to be accumulated in the repository 900 are represented by a dashed line.

In the feature extraction process A, the process_b, the process_g, and the process_h are the processes 7, which are initially conducted with respect to the original data 3. For respective processes 7, the output data 8 are generated in an order of “No. 1”, “No. 2”, and “No. 3”.

The process 7 to be conducted next is the process_m, which inputs the output data 8 of “No. 1” and “No. 2”. The output data 8 of “No. 4” are generated from the process_m. After that, the output data 8 of “No. 3” and “No. 4” are input to the process_p, which is further processed, and the output data 8 of “No. 5” are generated. The output data 8 of “No. 5” correspond to the learning data 9 acquired in the feature extraction process A.

In the feature extraction process B, the process_b, and the process_e, and the process_q are the processes 7, which are initially conducted with respect to the original data 3. For respective processes 7, the output data 8 are generated in an order of “No. 1”, “No. 6”, and “No. 7”. The output data 8 of “No. 1” is the same as one in the feature extraction process A. That is, The output data 8 of “No. 1” may be generated only once in the feature extraction process A.

Next, the process_m is conducted. In the process_m of the feature extraction process B, the output data 8 of “No. 1” and “No. 6” are input, and the output data 8 of “No. 8” are generated. Accordingly, the output data 8 of “No. 8” and “No. 7” are input to the process_p to be further conducted, and the output data 8 of “No. 9” are generated. The output data 8 of “No. 9” are regarded as the learning data 9 acquired in the feature extraction process B.

A characteristic of the output data 8 thus generated will be described. In the feature extraction processes A and B, the output data 8 of “No. 1”, “No. 2”, “No. 3”, “No. 6”, and “No. 7” are generated at the initial process stage are data generated from one process 7. Hence, compared with output data 8 generated by passing through the plurality of processes 7, the output data 8 of “No. 1”, “No. 2”, “No. 3”, “No. 6”, and “No. 7” may be highly reused.

In particular, the process_b may be highly repeated in this example. The use expectation value of the output data 8 of “No. 1” indicates “HIGH”. In addition, the execution time of the process_b indicates “LONG”, the accumulation necessity determination process 149 determines to accumulate the output data 8 of “No. 1” in the repository 900 (accumulation necessity: o).

However, in a case in which the output data 8 of “No. 7”, of which the execution time is short, do not influence the entire machine learning even if the process 7 is executed again, instead of accumulating in the repository 900, it is determined that a re-execution is preferable.

The output data 8 other than data generated at the initial process stage are generated by passing through two or more processes 7. The more the number of the executed processes 7 is until the output data 8 are generated, that is, the deeper a nesting of the processes 7 is, at the lower possibility the output data 8 are reused. In particular, it is determined that the output data 8 of “No. 5” and “No. 9”, which are generated at a last process stage and correspond to the learning data 9, are not accumulated (accumulation necessity: x).

In the embodiment, in a case of a process structure until the output data 8 of “No. 5” is generated, a description format representing a process structure may be indicated as follows:

p{m{b}{g}}{h}.

The process_p, which is positioned immediately before the output data 8 of “No. 5” is generated, is first defined in this format. Every process 7 traced back from the process_p is indicated by a process identification such as a process name or the like in { }. The above process structure indicates that immediately before the process_p, the process_m and the process_h are conducted. Moreover, the process structure indicates that immediately before the process_m, the process_b and the process_g are conducted.

In the embodiment, this process structure is maintained by using a meta information table 230, which will be described later. The accumulation necessity is determined by referring to the meta information table 230.

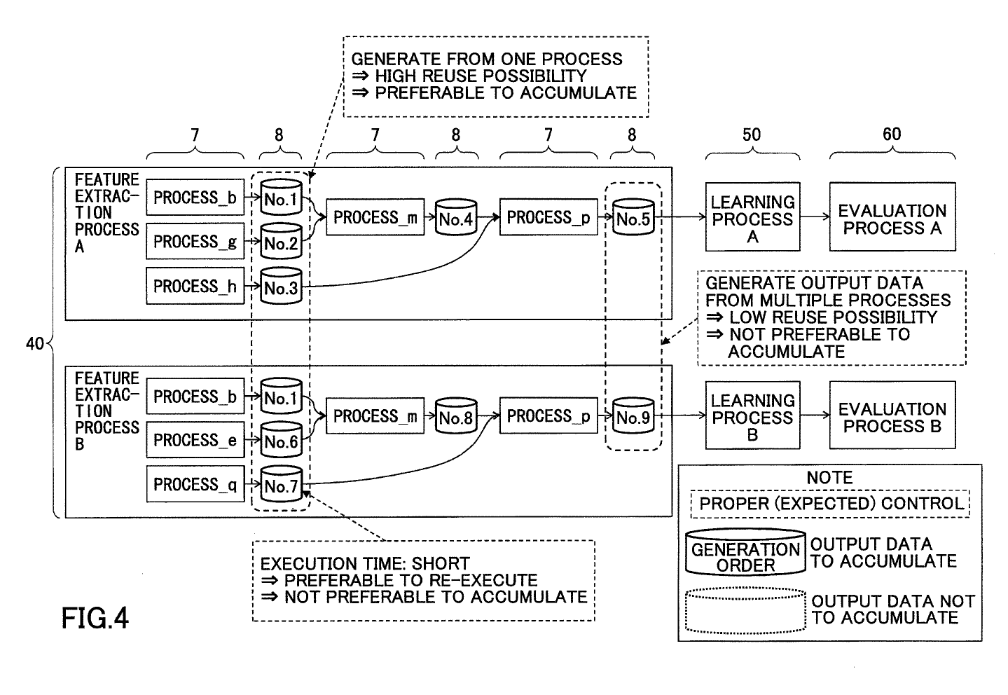

FIG. 4 is a diagram for explaining an example of a case in which the accumulation necessity determination process is not conducted. In FIG. 4, when the feature extraction process A and the feature extraction process B are conducted similar to FIG. 3, a case of deleting the output data 8 accumulated in the repository 900 based on an access frequency or the like to the output data 8 will be described. In the example in FIG. 4, all sets of the output data 8 are temporarily stored in the repository 900. Accordingly, a storage area for the output data 8 of “No. 1” through “No. 9” is demanded.

In FIG. 3, the output data 8 of “No. 1”, “No. 2”, “No. 3”, and “No. 6” alone are stored in the repository 900. On the contrary, in FIG. 4, in addition these sets of the output data 8, sets of the output data 8 of “No. 4”, “No. 5”, “No. 7”, “No. 8”, and “No. 9” are further stored in the repository 900.

Accordingly, a reuse possibility of the output data 8 in the embodiment does not always correspond to a use result at a time of accumulating the output data 8. Also, by conducting the accumulation necessity determination process 149 in the embodiment, it is possible to suppress an increase of a capacity usage of the repository 900 at the time of accumulating the output data 8, compared to the example in FIG. 4.

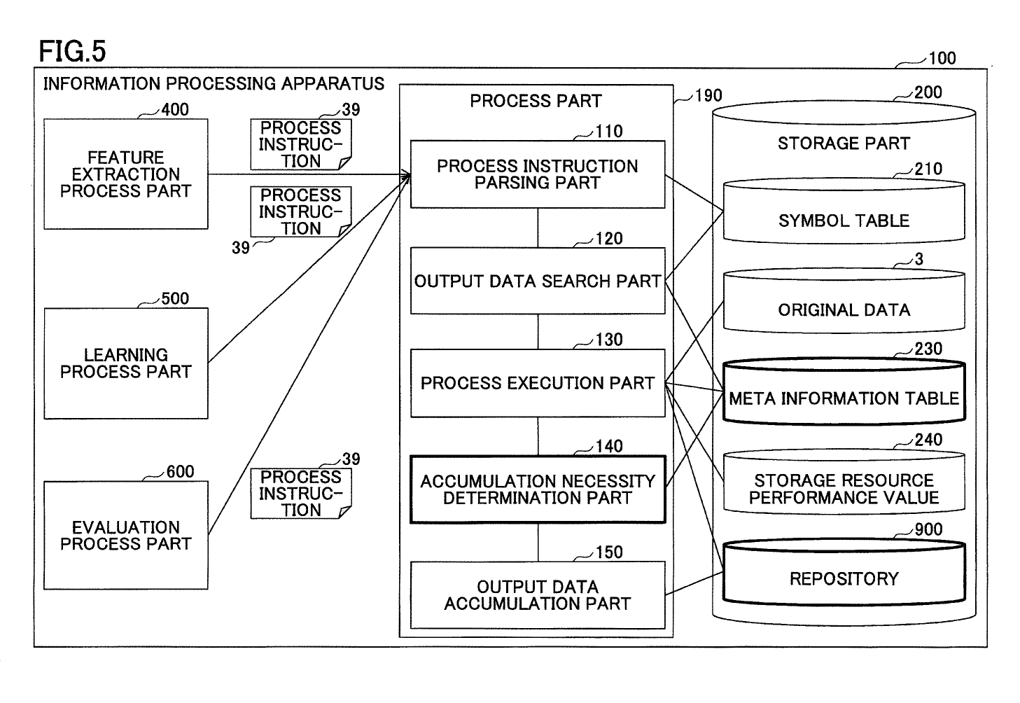

An example of a functional configuration of an information processing apparatus 100 for conducting the accumulation necessity determination process 149 will be described with reference to FIG. 5. FIG. 5 is a diagram illustrating the example of the functional configuration of the information processing apparatus. In FIG. 5, the information processing apparatus 100 is regarded as an apparatus that generates the model, and includes a feature extraction process part 400, a learning process part 500, an evaluation process part 600, and a process part 190.

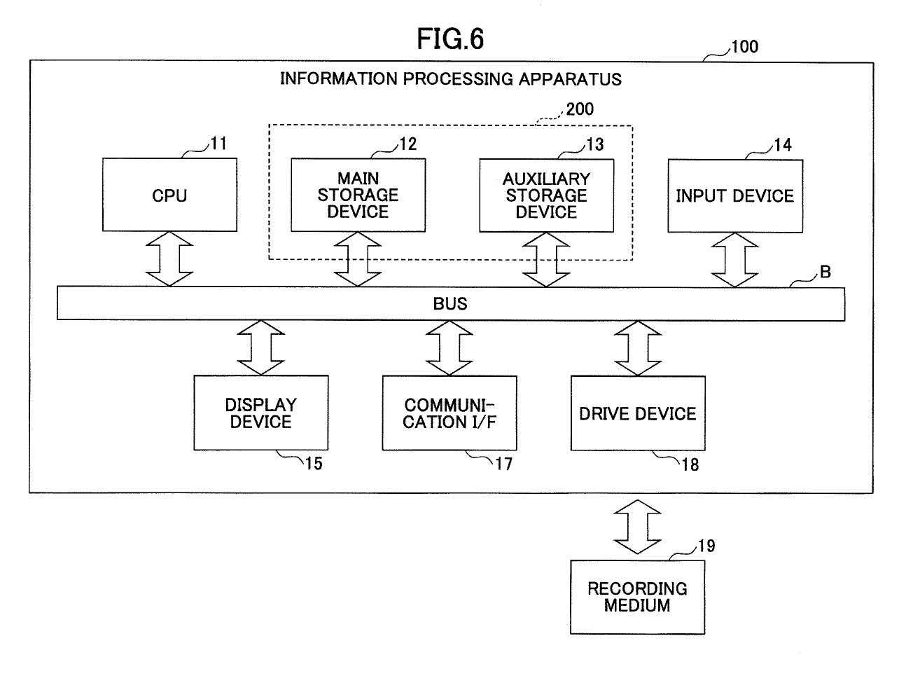

Each of the feature extraction process part 400, the learning process part 500, the evaluation process part 600, and the process part 190 is realized by a process, which a program installed into the information processing apparatus 100 causes a CPU 11 (FIG. 6) of the information processing apparatus 100 to perform.

Also, a storage part 200 of an information processing apparatus 100 (FIG. 5) stores a symbol table 210, the original data 3, the meta information table 230, and a storage resource performance value 240, the repository 900, and the like.

The feature extraction process part 400 conducts the feature extraction process 40. The learning process part 500 conducts the learning process 50. The evaluation process part 600 conducts the evaluation process 60.

The process part 190 receives a process instruction 39 from each of the feature extraction process part 400, the learning process part 500, and evaluation process part 600, determines an execution necessity of the process in accordance with the process instruction 39 and the accumulation necessity of the output data 8 generated by an execution of the process 7 to the repository 900.

The process part 190 includes a process instruction parsing part 110, an output data search part 120, a process execution part 130, an accumulation necessity determination part 140, and an output data accumulation part 150.

When receiving the process instruction 39, the process instruction parsing part 110 parses (analyzes) the process instruction 39, and decomposes a process command, an input name, and an output name. The process instruction 39 includes information of a program name or a command of a process to be executed, variables, the input name, and the output name. Hereinafter, the program name or the command, and the variables may be collectively called a “process command”.

The process instruction parsing part 110 creates a process content by referring to the analysis result of the process instruction 39 and the symbol table 210, and stores the output name and the created process content in the symbol table 210. When the same output name exists in the symbol table 210, the output name and the created process content are not stored in the symbol table 210.

The output data search part 120 acquires the process content from the output name by referring to the symbol table 210, and searches for the repository 900 by using an output ID corresponding to the process content in the meta information table 230.

When the output data 8 exists in the repository 900, the process 7 indicated by the process instruction 39 is assumed as completed. The process 7 is not executed by the process execution part 130. On the other hand, when the output data 8 do not exist in the repository 900, the process 7 is executed by the process execution part 130.

When the output data 8 do not exist in the repository 900, the process execution part 130 executes the process 7 indicated by the process instruction 39. The process execution part 130 applies an output ID for uniquely specifying the output data 8 in the repository 900 with respect to the output data 8 generated by executing the process 7, and adds the output data 8 in the meta information table 230 by associating with the execution time, the reuse time, and the like, which are acquired by executing the process 7.

The execution time is from a start to an end of the process 7. In a case of recording the generated output data 8 in the repository 900, the reuse time indicates time spent until a completion of reading out the output data 8. The reuse time is calculated by using the size of the output data 8 and the storage resource performance value 240.

The accumulation necessity determination part 140 refers to the meta information table 230, calculates two costs in the case in which the generated output data 8 are accumulated in the repository 900 and in the case in which the generated output data 8 are not accumulated in the repository 900, and determines the accumulation necessity of the output data 8. When a determination result indicates “not-accumulate”, the process 7 with respect to the received process instruction 39 is terminated without storing the output data 8 in the repository 900. The accumulation necessity determination part 140 is realized, when the CPU 11 (FIG. 6) executes the accumulation necessity determination program.

When the determination result indicates “accumulate”, the output data accumulation part 150 accumulates the output data 8 generated by the process execution part 130 in the repository 900.

The symbol table 210 stores the process content by associating with the output name for each of the output names. The repository 900 is regarded as a storage area to accumulate the output data 8 by associating with the output ID of the meta information table 230. The meta information table 230 stores the execution time, the reuse time, the use expectation value, the costs, the accumulation necessity, and the like for each of the process contents. The meta information table 230 will be described later. The storage resource performance value 240 indicates a throughput performance (MB/s) of the repository 900. The throughput performance may be measured and defined beforehand. Otherwise, a value measured during an operation may be set to the throughput performance.

In FIG. 5, the feature extraction process part 400, the learning process part 500, and evaluation process part 600 may be implemented in a terminal connected to the information processing apparatus 100 through a network. Also, the original data 3 and the repository 900 may be retained and maintained by one or more servers separately maintaining data.

The information processing apparatus 100 in the embodiment includes a hardware configuration as illustrated in FIG. 6. FIG. 6 is a diagram illustrating a hardware configuration of the information processing apparatus. In FIG. 6, the information processing apparatus 100 is controlled by a computer, and includes a Central Processing Unit (CPU) 11, a main storage device 12, an auxiliary storage device 13, an input device 14, a display device 15, a communication InterFace (I/F) 17, and a drive device 8, which are mutually connected via a bus B.

The CPU 11 corresponds to a processor that controls the information processing apparatus 100 in accordance with the program stored in the main storage device 12. The main storage device 12 includes a Random Access Memory (RAM), a Read Only Memory (ROM), and the like, and stores or temporarily stores the program executed by the CPU 11, data used in a process conducted by the CPU 11, data acquired in the process conducted by the CPU 11, and the like.

As the auxiliary storage device 13, a Hard Disk Drive or the like is used, to store data such as the programs to conduct various processes and the like. A part of the program stored in the auxiliary storage device 13 is loaded to the main storage device 12, and executed by the CPU 11, so as to realize the various processes. The main storage device 12 and the auxiliary storage device 13 correspond to the storage part 200.

The input device 14 includes a mouse, a keyboard, and the like, and is used by an analyzer such as a user to input various information items for the processes by the information processing apparatus 100. The display device 15 displays various information items for control of the CPU 11. The input device 13 and the display device 15 may be an integrated user interface such as a touch panel or the like. The communication I/F 17 conducts wired or wireless communications through a network. The communications by the communication I/F 17 are not limited to be wireless or wired.

The program realizing the processes conducted by the information processing apparatus 100 may be provided to the information processing apparatus 100 by a recording medium 19 such as a Compact Disc Read-Only Memory (CD-ROM) or the like, for instance.

The drive device 18 interfaces between the recording medium 19 (the CD-ROM or the like) set into the drive device 18 and the information processing apparatus 100.

Also, the program, which realizes the various processes according to the embodiment, is stored in the recording medium 19. The program stored in the recording medium 19 is installed into the information processing apparatus 100 through the drive device 18, and becomes executable by the information processing apparatus 100.

The recording medium 19 storing the program is not limited to the CD-ROM. The recording medium 19 may be any type of a recording medium, which is a non-transitory tangible computer-readable medium including a data structure. The recording medium 19 may be a portable recording medium such as a Digital Versatile Disc (DVD), a Universal Serial Bus (USB) memory, or the like, or a semiconductor memory such as a flash memory.

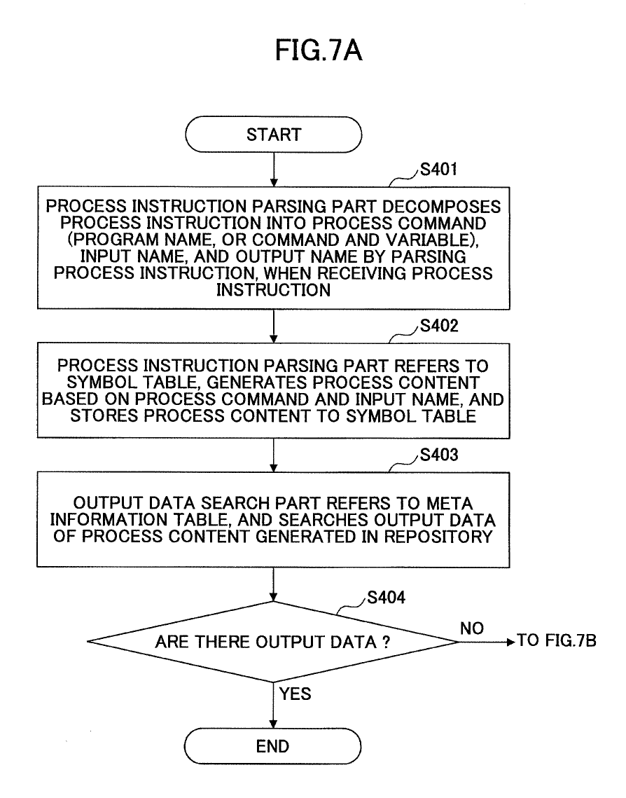

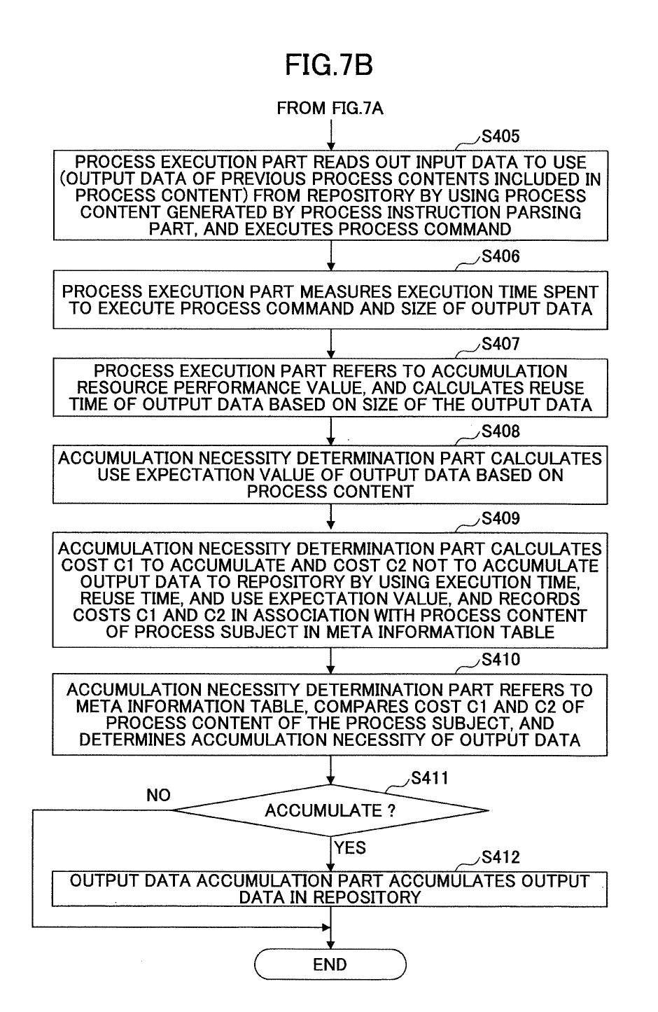

Next, a first example of the accumulation necessity determination process conducted by the information processing apparatus 100 for the output data 8 will be described. FIG. 7A and FIG. 7B are flowcharts for explaining the first example of the accumulation necessity determination process. In FIG. 7A, when receiving the process instruction 39, the process instruction parsing part 110 parses the process instruction 39, and decomposes the process instruction 39 into the process command, which includes the program name or the command and the variable for the process 7, the input name, and the output name (step s401).

The process instruction parsing part 110 refers to the symbol table 210 storing the process content for each of the output names, generates the process content of the received process instruction 39 based on the process command and the input name, and stores the symbol table 210 (step S402). The process content is generated to include the previous process contents, which processes have been retrospectively conducted.

Next, the output data search part 120 refers to the meta information table 230, and searches for the output data 8 of the generated process content from the repository 900 (step S403). It is determined whether the generated process content exists in the meta information table 230. When the generated process content exists, it is determined that the output data 8 exist.

The output data search part 120 determines whether the output data 8 exist (step S404). When the output data 8 exist (YES of step S404), the accumulation necessity determination process is terminated.

On the other hand, when the output data 8 does not exist (NO of step S404), the process execution part 130 reads out input data from the repository 900 by using the process content generated by the process instruction parsing part 110, and executes the process command (step S405 in FIG. 7B). The output data 8 of the previous process contents included in the process content are used as the input data.

Referring to FIG. 7B, the process execution part 130 measures the execution time when the process command is executed, and the size of the output data 8 generated by this execution (step S406), and calculates the reuse time of the output data 8 based on the size of the output data 8 by referring to the storage resource performance value 240 (step S407). The measured execution time and the calculated reuse time are stored in the meta information table 230.

Then, the accumulation necessity determination part 140 calculates the reuse expectation value of the output data 8 based on the process content (step S408).

Next, the accumulation necessity determination part 140 calculates a cost C1 in the case in which the output data 8 are accumulated in the repository 900 and a cost C2 in a case in which the output data 8 are not accumulated in the repository 900, by using the execution time and the reuse time acquired by the process execution part 130, and the reuse expectation value calculated by the accumulation necessity determination part 140, and records the cost C1 and the cost C2 in the meta information table 230 by associating with the process content of a process subject (step s409).

The accumulation necessity determination part 140 compares two costs C1 and C2 of the process content of the process subject by referring to the meta information table 230, and determines the accumulation necessity of the output data 8 (step S410), and determines whether to accumulate the output data 8 (step S411). When it is determined not to accumulate the output data 8 (NO of step S411), the accumulation necessity determination process is terminated.

On the other hand, when it is determined to accumulate the output data 8 (YES of step S411), the output data accumulation part 150 accumulates the output data 8 in the repository 900 (step S412). After that, the accumulation necessity determination process is terminated.

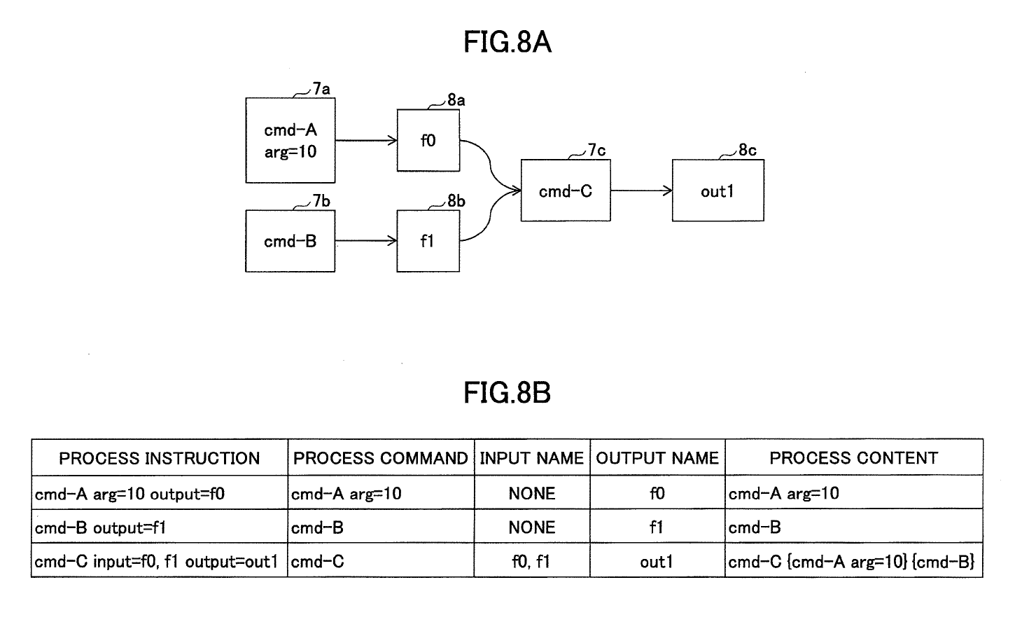

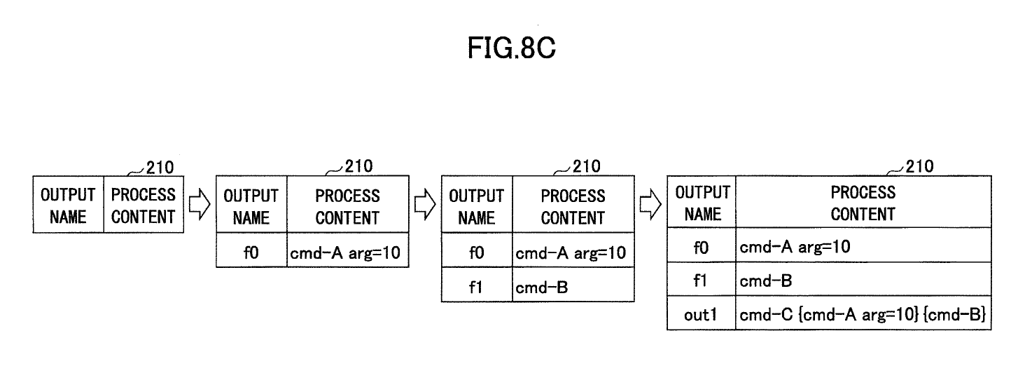

In step S402 in FIG. 7A, a method for generating the process content by the process instruction parsing part 110 will be described. FIG. 8A, FIG. 8B, and FIG. 8C are diagrams for explaining the method for generating the process content in step S402 in FIG. 7A.

Referring to an example of the process structure in FIG. 8A, the method for generating the process content will be described. In FIG. 8A, a process 7a and a process 7b correspond to the initial process stage in which the features are extracted based on values of the original data 3. A process 7c corresponds to the last process stage in which the output data 8c corresponding to the learning data 9 are generated. In a description example for the process 7a through the process 7c, “cmd” represents a command, and “arg” represents the variable. Accordingly, the process 7a is described as:

cmd-A

arg=10,

where “cmd-A” specifies the command, “arg=10” indicates the variable “10”. The process 7b indicates “cmd-B”, and the process 7c indicates “cmd-C”. Also, output data 8a, 8b, and 8c are respectively specified by f0, f1, and out1.

Next, a generation example of the process contents will be described with reference to FIG. 8B and FIG. 8C. In FIG. 8B, in an order of receiving the process instructions 39, an analysis result of the process instruction parsing part 110 is exemplified. In FIG. 8C, a state transition of the symbol table 210 is illustrated.

First, when receiving the process instruction 39 of “cmd-A arg=10 output=f0”, the process instruction parsing part 110 decomposes the process instruction 39 into a process command “cmd-A arg=10” and output name “f0”. In this example, since no input name is included, it is determined as “none” for the input name.

Since there is no input name in the process instruction 39, the process instruction parsing part 110 does not search for the symbol table 210. The process instruction parsing part 110 determines “cmd-A arg=10” as the process content, and adds a record, in which a content “cmd-A arg=10” is associated with the output name “f0” of the analysis result, to the symbol table 210.

One record, in which the content “cmd-A arg=10” is associated with the output name “f0”, is added to the symbol table 210, which is in an initial state, that is, in an empty state.

Next, when receiving the process instruction 39 of “cmd-B output=f1”, the process instruction parsing part 110 decomposes the process instruction 39 into a process command “cmd-B” and an output name “f1”. In this case, since the input name is not included, it is determined the input name as “none”.

Since no input name exists in the process instruction 39, the symbol table 210 is not searched. The process instruction parsing part 110 determines “cmd-B” as the process content, and adds a new record, in which the content “cmd-B” is associated with the output name “f1” of the analysis result, to the symbol table 210.

Moreover, when receiving the process instruction 39 of “cmd-C input=f0,f1 output=out1”, the process instruction parsing part 110 decomposes the process instruction 39 into a process command “cmd-C”, the input names “f0, f1”, an output name “out1”, and a process content “cmd-C {cmd-A arg=10} {cmd-B}”.

The process instruction parsing part 110 searches for the output name of the symbol table 210 by using each of the input names “f0” and “f1” indicated by the process instruction 39. The process instruction parsing part 110 acquires the process content “cmd-A arg=10” from the record of the output name “f0”, which is searched for in the symbol table 210 by using the input name “f0”. Also, the process instruction parsing part 110 acquires the process content “cmd-B” from the record of the output name “f1”, which is retrieved from the symbol table 210 by using the input name “f1”.

Accordingly, the process instruction parsing part 110 generates the process content “cmd-C {cmd-A arg=10} {cmd-B}” representing the process structure including from the current process 7c until the previous processes 7a and 7b in accordance with the above described description format, and adds the record, in which the process content “cmd-C {cmd-A arg=10} {cmd-B}” is associated with the output name “out1” of the analysis result, to the symbol table 210.

After that, every time receiving the process instruction 39, the process instruction parsing part 110 searches for the output name of the symbol name by the input name acquired by analyzing, and acquires the previous process contents. The process instruction parsing part 110 generates the process content of the received process instruction 39 in a predetermined description format. Also, the process instruction parsing part 110 adds the record, in which the generated process content is associated with the output name acquired by the analysis, to the symbol table 210.

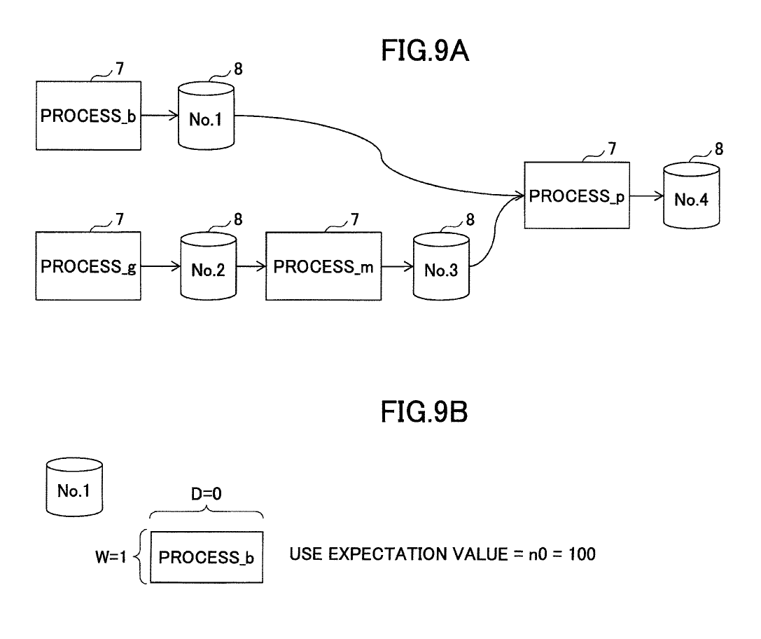

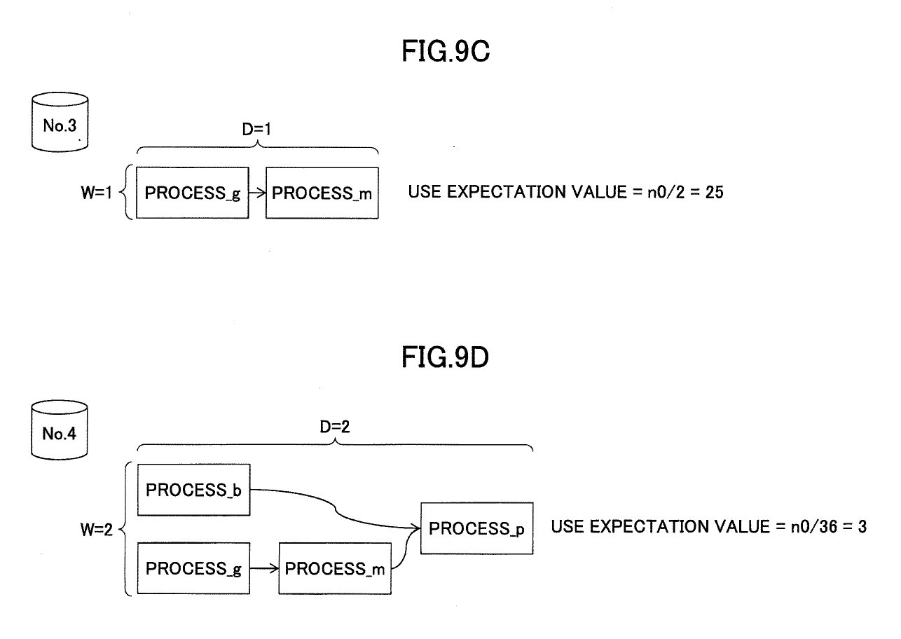

Next, in step S408 in FIG. 7B, a method for calculating the user expectation value by the accumulation necessity determination part 140 will be described. FIG. 9A through FIG. 9D are diagrams for explaining the method for calculating the use expectation value in step S408 in FIG. 7B.

Referring to a process structure in FIG. 9A, the method for calculating the use expectation value will be described. In FIG. 9A, the process name is indicated for each of the processes 7, and the generation order is indicated for each set of the output data 8. The output data 8 of “No. 1” is generated in the process_b, the output data of “No. 2” is generated in the process_g, the output data of “No. 3” is generated in the process_m, and the output data of “No. 4” is generated in the process_p.

A complexity of the process structure is calculated so that the greater a width W is, the greater the complexity is and the deeper a depth D is, the greater the complexity is. The use expectation value of the output data 8 is calculated so that the greater the complexity is, the smaller the use expectation value is.

The complexity of the process structure is expressed as follows:

complexity=W×(D+1).

The width W indicates a number of the inputs to the process 7, which generates the output data 8. The depth D indicates a number of stages of the previous processes 7 until the current process 7.

Also, the use expectation value of the output data 8 is expressed as follows:

$$\begin{matrix}use expectation value = n 0 / {( complexity )}^{2} \\ = n 0 / {( W \times ( D + 1 ) )}^{2} .\end{matrix}$$

In this expression, n0 indicates the use expectation value of a default defined beforehand. In the following, a case of n0=100 will be described.

In FIG. 9B, the use expectation value of the output data 8 of “No. 1” will be described. The use expectation value of the output data 8 of “No. 2” is acquired in the same manner. The process 7 for generating the output data 8 of “No. 1” corresponds to the process_b, and there is no process 7 conducted prior to the process_b. Accordingly, the width W=1, and the depth D=0. Thus, the following expression is acquired:

complexity=1×(0+1)=1.

Accordingly, the use expectation value is acquired:

use expectation value=100/(1)²=100.

The use expectation value of the output data 8 of “No. 2” is also “100”.

In FIG. 9C, the use expectation value of the output data 8 of “No. 3” will be described. The process 7, which generates the output data 8 of “No. 3”, is the process_m, and the process_g is conducted prior to the process_m. The number of the inputs to the process_m is “1”. Thus, the with W=1, and the depth D=1. The complexity is acquired as follows:

complexity=1×(1+1)=2.

Accordingly, the use expectation value is acquired as follows:

$$\begin{matrix}use expectation value = 100 / {( 2 )}^{2} \\ = 100 / 4 \\ = 25.\end{matrix}$$

In FIG. 9D, the use expectation value of the output data 8 of “No. 4” will be described. The process 7, which generates the output data 8 of “No. 4”, is the process_p, and the process_b and the process_m are conducted prior to the process_p. The number of the inputs to the process_p is “2”. As described above, the process_g is conducted prior to the process_m. Accordingly, the width W=2 and the depth D=2. The complexity is calculated as follows:

complexity=2×(2+1)=6.

Accordingly, the user expectation value is calculated as follows:

$$\begin{matrix}use expectation value = 100 / {( 6 )}^{2} \\ = 100 / 36 \\ = 3.\end{matrix}$$

The process content of the process_p, which generates the output data 8 of “No. 4” is represented as follows:

cmd_p{cmd_b}{cmd_m{cmd_g}}.

By using the description of the process content, the use expectation value is calculated in the same manner described above. A number of outermost parentheses described following cmd_p is represented by the width W, and a maximum number of the parentheses among multiple counts of inner parentheses included in respective outermost parentheses is represented by the depth D. Accordingly, the width W (the number of the outermost parentheses)=2 and the depth D (the maximum number of the inner parentheses)=2 are acquired by referring to the process content of the process_p. That is, the number of the parentheses existing in the process content of the process_p may be simply counted.

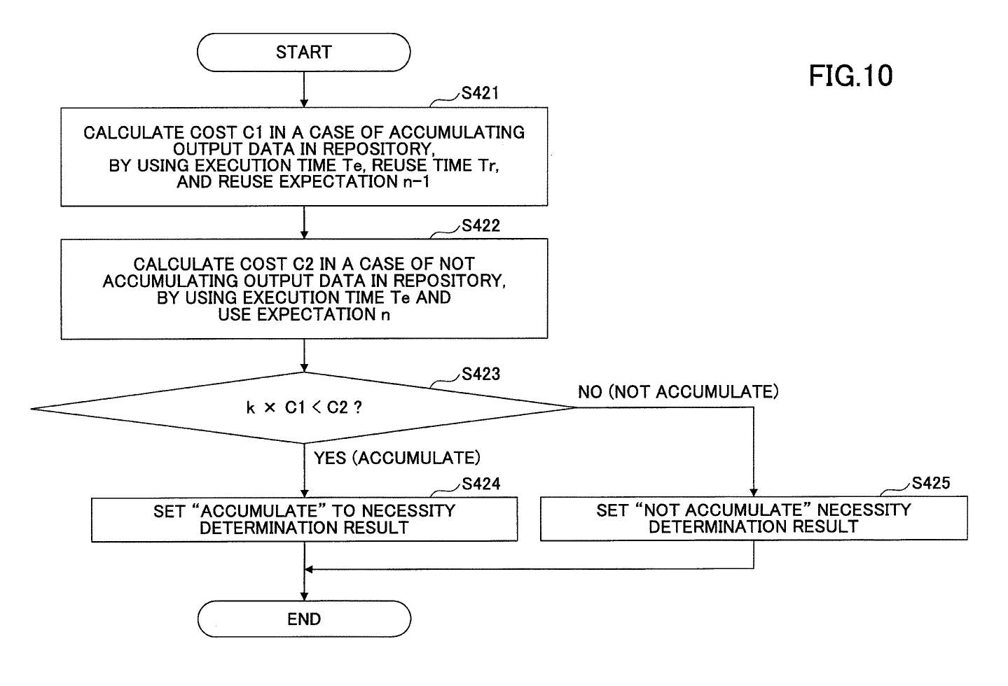

Next, in steps S409 and S410 in FIG. 7B, the accumulation necessity determination part 140 determines the accumulation necessity by calculating the cost C1 and the cost C2. This accumulation necessity determination process will be described. FIG. 10 is a diagram for explaining a cost calculation in step S409 and the accumulation necessity determination process in step S410 in FIG. 7B.

In FIG. 10, the accumulation necessity determination part 140 calculates the cost C1 in a case in which the output data 8 are accumulated in the repository 900 by using the execution time Te, the reuse time Tr, and the use expectation value n (step S421). The cost C1 is calculated as follows:

cost C1=execution time Te×reuse time Tr×(use expectation value n−1).

In the above calculation of the cost C1, the use expectation value n is deducted by 1.

Also, the accumulation necessity determination part 140 calculates the cost C2 in the case in which the output data 8 are not accumulated in the repository 900, by using the execution time Te and the use expectation value n (step S422). The cost C2 is calculated as follows:

cost C2=execution time Te×use expectation value n.

The cost C1 may be calculated after the cost C2 is calculated. The costs C1 and C2 may be calculated with any calculation order.

After that, the accumulation necessity determination part 140 determines whether a value acquired by multiplying a constant k with the cost C1 is less than the cost C2 (step S423). When a value pertinent to the cost C1 is less than the cost C2 (YES of step S423), the accumulation necessity determination part 140 sets “accumulate” to the determination result of the accumulation necessity (step S424), and terminates the cost calculation and the accumulation necessity determination process.

On the other hand, when the value pertinent to the cost C1 is greater than or equal to the cost C2 (NO of step S423), the accumulation necessity determination part 140 sets “not accumulate” to the determination result (step S425), and terminates the cost calculation and the accumulation necessity determination process.

A method for determining the constant k will be described. A first method will be described. In a case in which the capacity of the repository 900 being an accumulation resource is relatively small, if the number of sets of the output data 8 to be accumulated is greater, the capacity shortage of the accumulation resource is quickly caused. Thus, a greater value is set to the constant k. As an example, “3” may be set to the constant k.

A second method will be described. A use state of the repository 900 being the accumulation resource may be monitored and the constant k may be changed depending on a remaining capacity of the repository 900. As an example, when the remaining capacity falls in a range of 10% to 50% of a total capacity, the constant k=1.5 is defined. When the remaining capacity is less than 10% of the total capacity, the constant k=2 is defined.

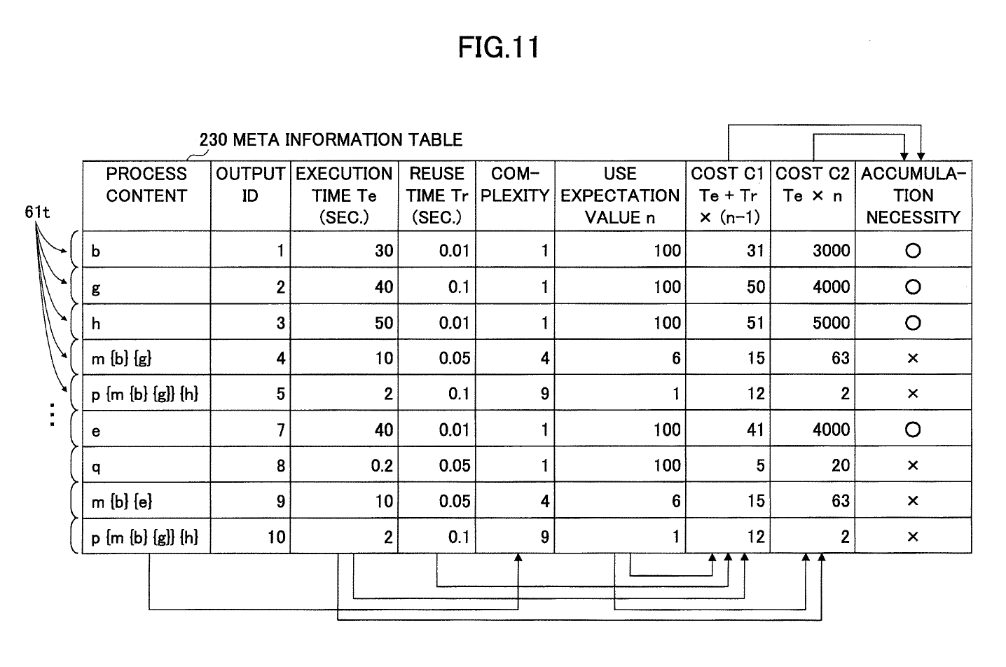

FIG. 11 is a diagram illustrating a first data example of the meta information table. In FIG. 11, the meta information table 230 records and maintains information used to determine the accumulation necessity of the output data 8 and a determination result of the accumulation necessity for each of the process contents, and includes items of “PROCESS CONTENT”, “OUTPUT ID”, “EXECUTION TIME Te”, “RE-USE TIME Tr”, “COMPLEXITY”, “USE EXPECTATION VALUE n”, “COST C1”, “COST C2”, “ACCUMULATION NECESSITY”, and the like.

The item “PROCESS CONTENT” indicates the process content generated by the process instruction parsing part 110. The item “OUTPUT ID” indicates a number for specifying the output data 8. The output data 8 are retained in the storage part 200, in which the output ID is used as a file name. Hence, it becomes easy to specify the output data 8 when the output data 8 are used.

The item “EXECUTION TIME Te” indicates time by second from the start to the end of the process 7 executed by the process execution part 130. The item “RE-USE TIME Tr” indicates time spent to reuse the output data 8 calculated by the process execution part 130.

The item “COMPLEXITY” indicates a complex level of the process structure calculated by the accumulation necessity determination part 140. The item “USE EXPECTATION VALUE n” indicates a likelihood of using the output data 8, which is calculated by the accumulation necessity determination part 140 based on the complexity.

The item “COST C1” indicates the cost calculated by the accumulation necessity determination part 140 in the case in which the output data 8 are accumulated in the repository 900. The item “COST C2” indicates the cost calculated by the accumulation necessity determination part 140 in the case in which the output data 8 are not accumulated in the repository 900 and the same output data 8 are generated by executing the same process 7.

The item “ACCUMULATION NECESSITY” indicates the determination result by the accumulation necessity determination part 140. The mark “o” indicates that the accumulation necessity determination part 140 determines to accumulate the output data 8. The mark “x” indicates that the accumulation necessity determination part 140 determines not to accumulate the output data 8.

A value in the item “PROCESS CONTENT” in meta information table 230 is referred to in calculating the complexity. The complexity is referred to in calculating the use expectation value n. The execution time Te, the reuse time Tr, and use expectation value n are referred to in calculating the cost C1. Also, the execution time Te and the use expectation n are referred to in calculating the cost C2. Then, the cost C1 and the cost C2 are used to determine the accumulation necessity.

In FIG. 11, a data example in the process structure depicted in FIG. 3 is illustrated when a default use expectation value n0=100 and the constant k=5 for a cost comparison.

The output data 8 of the output ID “1” is generated by the process content “b”, and the execution time Te is “30” seconds in an operation related to the output ID “1”, and the reuse time Tr is “0.01” seconds. Based on these sets of information, the complexity “1”, the use expectation value n “100”, the cost C1, and the cost C2 are acquired. Accordingly, a value “155” resulted from multiplying 5 to the cost C1 “31” (5×31) is less than the cost C2 “3000”, and the mark “o” of the accumulation necessity is recorded.

The process instruction 39 is successively received, and the accumulation necessities “o”, “o”, “x”, and “x” are determined for the output data 8 with respect to the process contents “g”, “h”, “m {b} {g}”, and “p {m {b} {g}} {h}” acquired by the analysis. From the determination results of the accumulation necessities, in the feature extraction process A of the process structure in FIG. 3, the output data 8 of “No. 1”, “No. 2”, and “No. 3” are accumulated and retained in the repository 900. However, the output data of “No. 4” and “No. 5” are not accumulated in the repository 900.

By conducting the feature extraction process B, the output data 8 of “No. 6” are accumulated and retained in the repository 900. However, the output data 8 of “No. 7”, “No. 8”, and “No. 9” are not accumulated in the repository 900. In the feature extraction process B, the output data 8 of “No. 6” alone are newly accumulated in the repository 900.

In the embodiment, by determining the accumulation necessity of the process data 8 generated by executing the process 7, it is possible to suppress an increase of an accumulation capacity of the repository 900.

In FIG. 11, by referring to the process structure in FIG. 3, a variation of a timing of determining the accumulation necessity will be described. A first timing 61t indicates a timing of generating the output data 8. As described above with reference to the flowchart in FIG. 7, every time the output data 8 are generated, the accumulation necessity is determined.

Next, in an example of a successive feature extraction, a case, in which the accumulation necessity is determined at a second timing 62t for each learning, will be described. It is also assumed that the example of the successive feature extraction is based on the process structure in FIG. 3.

In an accumulation necessity determination for each learning, when plurality of feature extraction processes 40 are conducted, every time the learning process 50 is executed for each of the feature extraction processes 40, the accumulation necessity determination is collectively conducted for all the plurality of sets of the output data 8 generated by the feature extraction process 40.

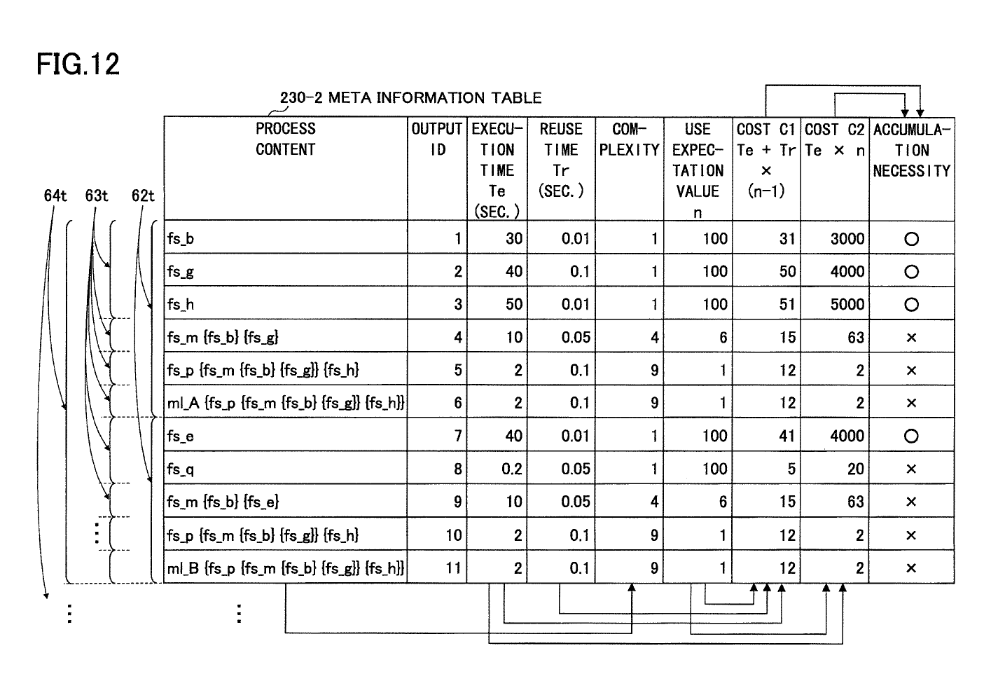

FIG. 12 is a diagram illustrating a second data example of the meta information table. In FIG. 12, the items of a meta information table 230-2 are the same as those of the meta information table 230 depicted in FIG. 11, and the explanation thereof will be omitted.

The second timing 62t is time when the feature extraction process 40 ends. When the feature extraction process 40 ends, that is, after the learning data 9 are generated, the accumulation necessity determination is collectively conducted for all the plurality of sets of the output data 8 generated by the feature extraction process 40. A case of indicating the command in the process instruction 39 will be described. Also, a case in which the program is indicated in the process instruction 39 may be applied in the same manner.

A process type is indicated to the command indicated in the process instruction 39, and the process types and a definition rule for distinguishing each of the process types are defined. As an example, the followings are defined:

process type:

the “feature extraction process” and the “learning process”, are distinguishable.

definition rule:

a prefix for the “feature extraction process”=“fs_”

a prefix for the “learning process”=“ml_”.

In the second data example in FIG. 12, when the command “ml_A” is detected in the process content, the accumulation necessity determination part 140 conducts the accumulation necessity determination with respect to the process contents, to which the accumulation necessity has not been determined. With respect to each of a plurality of sets of the output data 8 from “No. 1” to “No. 5” generated in the feature extraction process A in FIG. 3, the accumulation necessity determination is conducted.

Next, when the command “ml_B” is detected in the process content, the accumulation necessity determination part 140 conducts the accumulation necessity determination with respect to the process contents, for which the accumulation necessity has not been determined, in the meta information table 230-2. With respect to each of the plurality of sets of the output data 8 from “No. 6” to “No. 9” generated in the feature extraction process B in FIG. 3, the accumulation necessity determination is conducted.

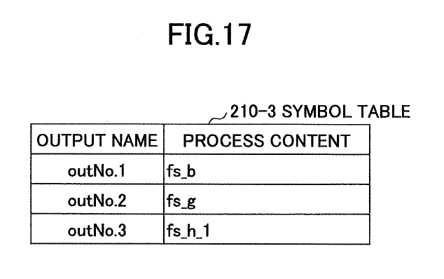

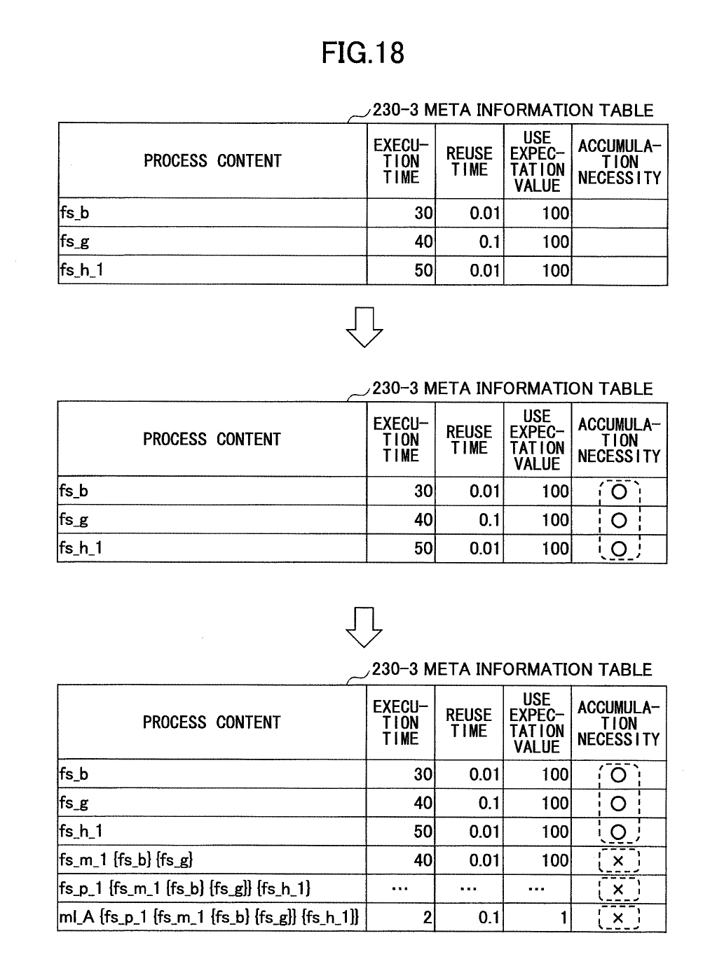

Also, a third timing 63t is time when each of process stages ends. When each of the process stages ends, the accumulation necessity determination is conducted for the output data 8. At the third timing 63t, a suffix such as “_1”, “_e”, or the like is added at an end of the command of the same stage. The accumulation necessity determination part 140 conducts the accumulation necessity determination every time the suffix is detected. A case of the third timing 63t will be described later with reference to FIG. 16, FIG. 17, and FIG. 18.

Furthermore, a fourth timing 64t is time when a generation ends. At an end of the generation, the accumulation necessity determination of the output data 8 is conducted. In a case of the fourth timing 64t, the suffix such as “_1”, “_e”, or the like is added to the command (indicating “ml_”) of the learning process 50 at a last stage in the generation. Every time the suffix of the command starting from “ml_” is detected, the accumulation necessity determination part 140 conducts the accumulation necessity determination.

At least, in the accumulation necessity determinations at the third timing 63t and the fourth timing 64t, regardless of presence or absence of the suffix, the process execution part 130 regards and executes the command as the same one.

Next, a concrete example of a change of data in the meta information table 230 in the accumulation necessity determination process will be described. In the following, a second example of the accumulation necessity determination process will be described in which the data maintained in the meta information table 230 are changed. In the second example of the accumulation necessity determination process, the accumulation necessity determination for the output data 8 at the second timing 62t will be described.

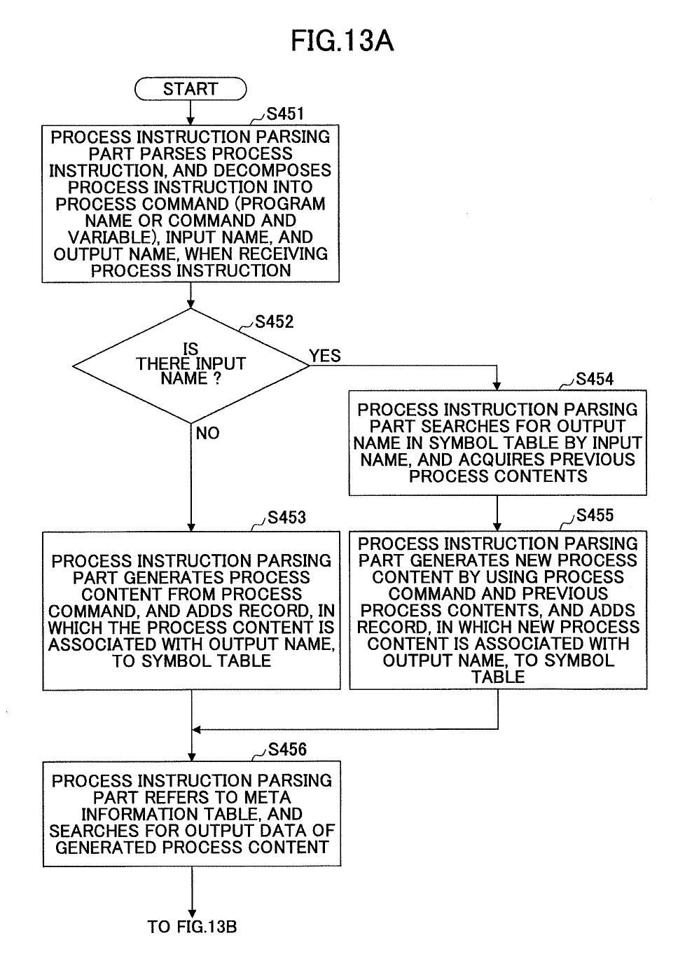

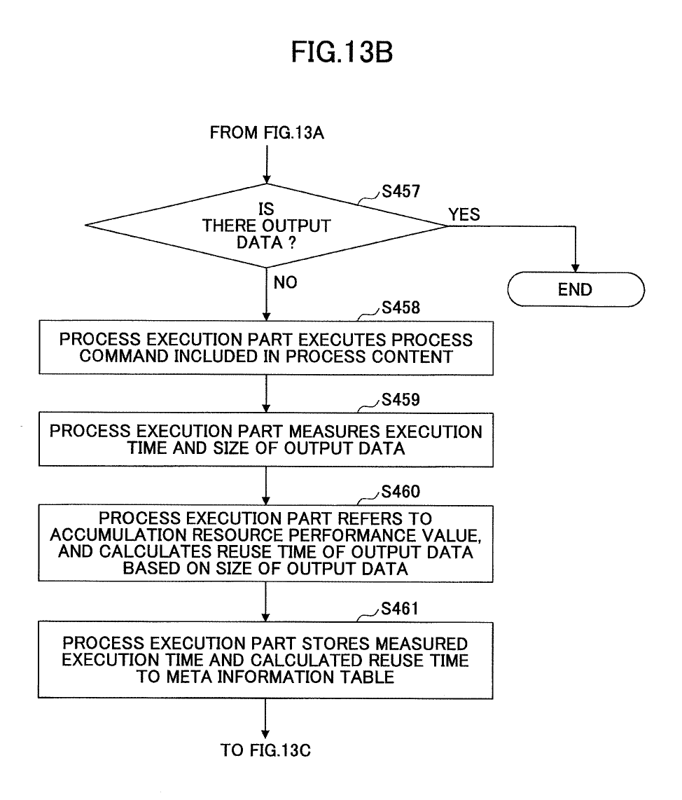

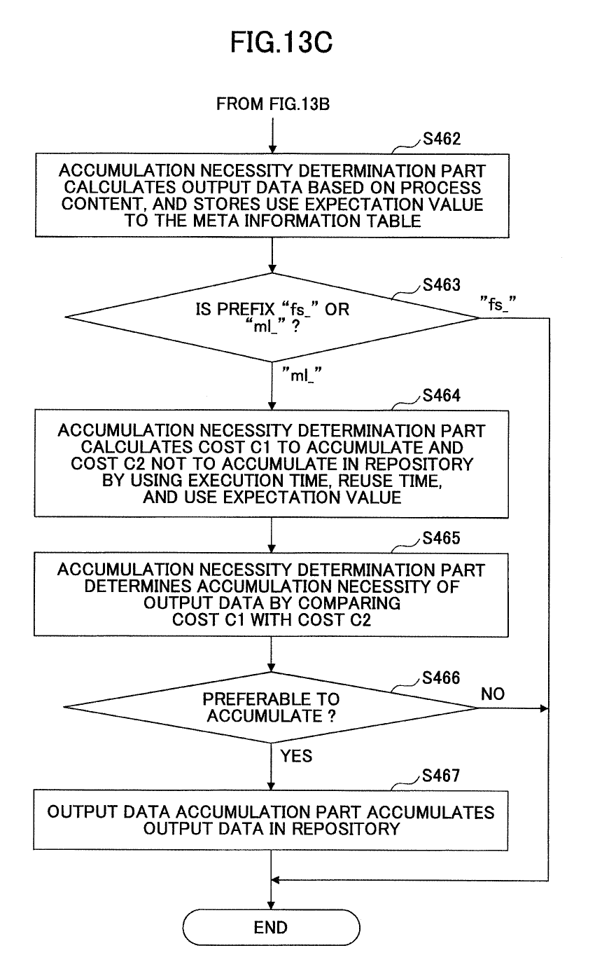

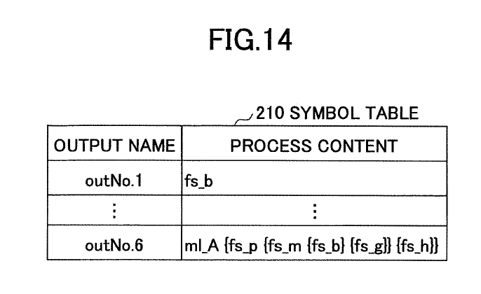

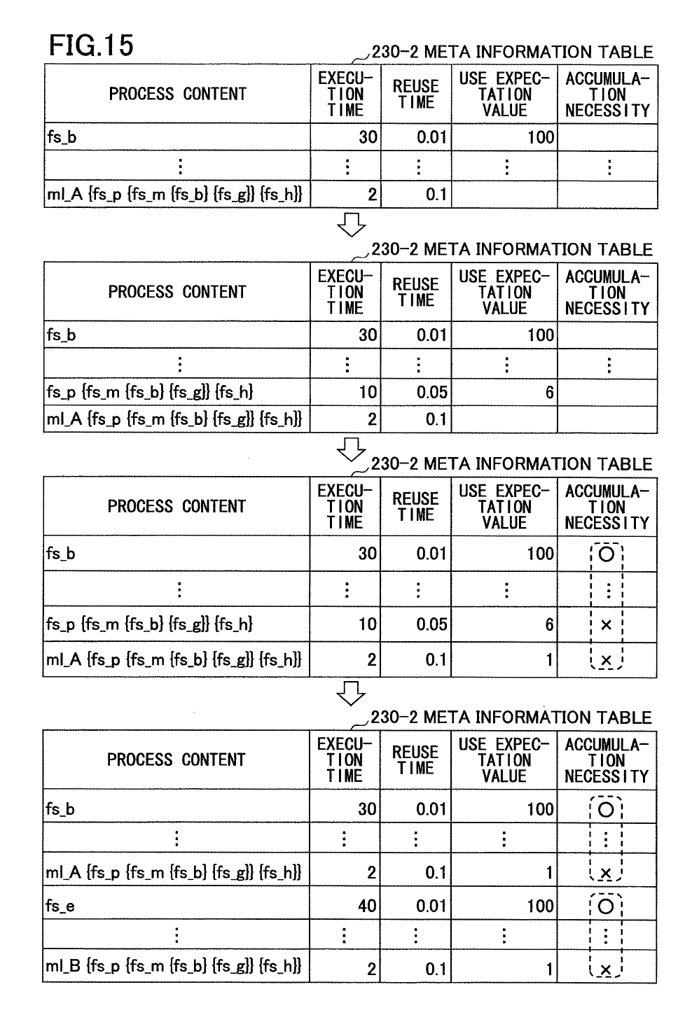

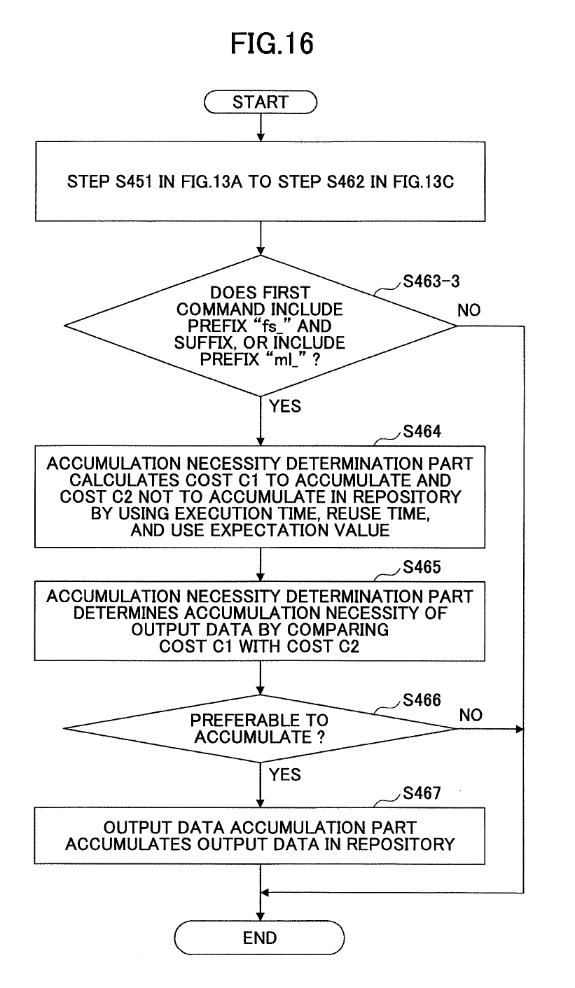

FIG. 13A through FIG. 13C, FIG. 14, and FIG. 15 are diagrams for explaining a second example of the accumulation necessity determination process. In FIG. 13A, when receiving the process instruction 39, the process instruction parsing part 110 parses the process instruction 39, and decomposes the process command including the program name or the command of the process 7 and the variable, the input name, and the output name (step S451).

The process instruction parsing part 110 determines whether there is the input name (step S452). When there is no input name (NO of step S452), the process instruction parsing part 110 generates the process content from the process command, and adds the record, in which the generated process content is associated with the output name, to a symbol table 210-2 (FIG. 14) (step S453).

On the other hand (YES of step S452), the process instruction parsing part 110 searches for the output name of the symbol table 210-2 by using the input name, and acquires the previous process contents (step S454). Then, the process instruction parsing part 110 generates a new process content based on the process command and the acquired previous process contents, and adds the record, in which the generated new process content is associated with the output name, in the symbol table 210-2 (step S455).

After a process of steps S453 or S455, the output data search part 120 refers to the meta information table 230, and searches for the output data 8 of the generated process content (step S456). It is determined whether the generated process content exists in the meta information table 230. When the generated process content exists, it is determined that the output data 8 corresponding to the generated process content have been stored in the repository 900.

Referring to FIG. 13B, the output data search part 120 determines whether the output data 8 exist (step S457). When the output data 8 exist (YES of step S457), the accumulation necessity determination process is terminated.

On the other hand, when the output data 8 do not exist (NO of step S457), the process execution part 130 reads out the input data from the repository by using the process content generated by the process instruction parsing part 110, and executes the process command (step S458). The output data 8 of the previous process contents included in the process content are used as the input data.

The process execution part 130 measures the execution time when the process command is executed, and the size of the output data 8 generated by the execution (step S459), and calculates the reuse time of the output data 8 based on the size of the output data 8 by referring to the storage resource performance value 240 (step S460). Then, the process execution part 130 stores the measured execution time and the calculated reuse time in the meta information table 230-2 (step S461).

Referring to FIG. 13C, the accumulation necessity determination part 140 calculates the reuse expectation value of the output data 8 based on the process content, and stores the calculated reuse expectation value in the meta information table 230-2 (step S462).

The accumulation necessity determination part 140 determines whether the prefix of a first command in the process content is “fs_” or “ml_” (step S463). When the prefix is “fs_” (“fs_” of step S463), the necessity determination of the output data 8 is not conducted, and the accumulation necessity determination process is terminated. The process part 190 waits until the next process instruction 39 is received.

Processes from step S451 in FIG. 13A to step S463 in FIG. 13C are repeated. At this stage, the accumulation necessity has not been determined from the process content “fs_b” to the process content “fs_p {fs_m {fs_b} {fs_g}} {fs_h}”. Hence, a plurality of sets of the output data 8 from the process content “fs_b” to the process content “fs_p {fs_m {fs_b} {fs_g}} {fs_h}” have not been stored in the repository 900. By further repeating the processes, regarding to the process content “ml_A {fs_p {fs_m {fs_b} {fs_g}} {fs_h}}”, the execution time and the reuse time are stored in the meta information table 230-2 (FIG. 15).

In this case, a process for a case of the prefix “ml_” (“ml_” of step S463) is conducted. That is, the accumulation necessity determination part 140 determines the accumulation necessity from the process content “fs_b” to the process content “ml_A {fs_p {fs_m {fs_b} {fs_g}} {fs_h}}” (FIG. 15). Similarly, the accumulation necessity is determined for each set of the output data 8 from the process content “fs e” to the process content “ml_B {fs_p {fs_m {fs_b} {fs_g}} {fs_h}}” (FIG. 15).

First, the accumulation necessity determination part 140 conducts the accumulation necessity determination from steps S464 to S467 with respect to each set of the output data 8, to which the accumulation necessity has not been determined.

The accumulation necessity determination part 140 calculates the cost C1 in the case in which the output data 8 are accumulated in the repository 900 and the cost C2 in the case in which the output data 8 are not accumulated in the repository 900 by using the execution time, the reuse time, and the use expectation value (step S464).

Next, the accumulation necessity determination part 140 determines the accumulation necessity of the output data 8 by comparing the cost C1 with the cost C2 (step S465), and checks whether the determination result indicates “accumulate” (step S466). When the determination result indicates “not accumulate” (NO of step S466), that is, when there is the output data 8, to which the accumulation necessity has not been determined, the above described processes from step S464 are repeated in the same manner. When the accumulation necessity determination is completed for all sets of the output data 8, which have not been determined, the accumulation necessity determination process is terminated, and the process part 190 waits until the next process instruction 39 is received.

On the other hand, when the accumulation necessity determination part 140 determines to accumulate the output data 8 (YES of step S466), the output data accumulation part 150 accumulates the output data 8 in the repository 900 (step S467). If there is the output data 8, which have not been determined, the above processes from step S464 are repeated in the same manner. When the accumulation necessity determination is completed for all output data 8, the accumulation necessity determination process is terminated, and the process part 190 waits for the next process instruction 39.

FIG. 16 is a flowchart for explaining a third example of the accumulation necessity determination process. FIG. 16 illustrates an example of a case of conducting the accumulation necessity determination process with respect to the plurality of sets of the output data at the third timing. FIG. 17 is a diagram illustrating a data example of symbol table in a case of the third timing, and FIG. 18 is a diagram illustrating a data transition example of the meta information table.

Steps S451 to S462 in FIG. 13A to FIG. 13C are conducted in the same manner, and the explanation thereof will be omitted. However, in FIG. 17 and FIG. 18, data examples of the symbol table 210-3 and the meta information table 230-3 are depicted for the accumulation necessity determination at each of process stages.

In FIG. 17, the symbol table 210-3 indicates states of recording the process_b, the process_g, and the process_h at the initial process stage in the feature extraction process A in FIG. 3. For the process_h, the prefix “fs_” and the suffix “_1” are added.

Also, in FIG. 18, the meta information table 230-3 records the execution time, the reuse time, and the use expectation value for each of the generated process contents. There is no process content, to which the accumulation necessity is determined.

Different from the flowchart in FIG. 13A through FIG. 13C for explaining the accumulation necessity determination process at the second timing, step S463 is replaced with step S463-3 in the flowchart in FIG. 16. Steps other than step S463-3 are the same as those in FIG. 13A through FIG. 13C, and the explanation thereof will be omitted.

The accumulation necessity determination part 140 determines whether the first command, in the process content generated based on the received process instruction 39, includes the prefix “fs_” and the suffix, or includes the prefix “ml_” (step S463-3). When this determination condition is not satisfied (NO of step S463-3), the accumulation necessity of the output data 8 is not conducted and the accumulation necessity determination process is terminated. The process part 190 waits for the next instruction 39.

Every time the process instruction 39 is received, processes from step S451 to step S463-3 are repeated, and the process contents from “fs_b” to “fs_h_1” are recorded in the meta information table 230-3 without determining the accumulation necessity. The output data 8 from the process content “fs_b” to the process content “fs_h_1” have not been stored in the repository 900. When the processes are repeated for the process content “fs_h_1”, the execution time, the reuse time, and the use expectation value are recorded in the meta information table 230-3.

In this case, the determination condition is satisfied (YES of step S463-3). That is, the accumulation necessity determination part 140 determines the accumulation necessity for all sets of the output data 8 from the process content “fs_b” to the process content “fs_h_1”. After that, the accumulation necessity is determined when the output data 8 is generated for each of the process contents “fs_m_1 {fs_b} {fs_g}”, “fs_p_1 {fs_m_1 {fs_b} {fs_g}} {fs_h_1}”, and “ml_A {fs_p_1 {fs_m_1 {fs_b} {fs_g}} {fs_h_1}}” (FIG. 18).

The accumulation necessity determination processes of the output data 8 at the first timing 61t to the third timing 63t are described above. In the genetic algorithm, the accumulation necessity determination process may be conducted at the fourth timing 64t when the generation ends. With respect to each of the plurality of sets of the output data 8 generated in the same generation, the accumulation necessity is determined.

For the accumulation necessity determination at the fourth timing 64t, the determination condition in step S463-3 in FIG. 16 may be replaced with a condition in which the suffix is “ml_” and the prefix exists. Hence, the explanation thereof will be omitted.

As described above, in the embodiment, it is possible to realize a data accumulation with high efficiency of reuse in a process for acquiring a final result by passing through the multiple processes, in which the output data 8 being accumulated are expected to be reused in the future.

Accordingly, it is possible to accumulate data with high efficiency of reuse in a data process including multiple processes in which an output result of one process is used in another process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a data accumulation determining program that causes a computer to execute a process comprising:
calculating a first cost and a second cost from a process content pertinent to a process for acquiring a final result by a plurality of processes, the process content including a plurality of process contents respective to a plurality sets of the output data generated in paths until the final result is acquired by the plurality of processes from subject data, the first cost corresponding to a cost for accumulating the output data in a repository, the second cost corresponding to a cost for generating the output data that are not accumulated in the repository; and
determining an accumulation necessity for each of the plurality of sets of the output data based on the first cost and the second cost.

2. The non-transitory computer-readable recording medium according to claim 1, further comprising:
determining the accumulation necessity of the output data, upon generation for each of the plurality of sets of the output data.

3. The non-transitory computer-readable recording medium according to claim 1, further comprising:
conducting a trial multiple times, the trial executing a second type process for every multiple executions of a first type process with respect to the subject data; and
determining the accumulation necessity for each of the plurality of sets of the output data, which are generated by executing the first type process multiple times, after the multiple executions of the first type process.

4. The non-transitory computer-readable recording medium according to claim 3, wherein
the process includes a process type, and
the data accumulation determination process further includes
determining the accumulation necessity for each of the plurality of sets of the output data generated by a feature extraction process, for the process type that indicates a learning process conducted by following the feature extraction process.

5. The non-transitory computer-readable recording medium according to claim 3, further comprising:
determining the accumulation necessity for each of one or more sets of the output data in response to ends of the processes at a same stage, the one or more sets of the output data being generated at each of stages in a structure in which the output data generated at a previous stage are input to the process at a following stage among the plurality of processes.

6. The non-transitory computer-readable recording medium according to claim 1, further comprising:
conducting a trial a certain number of times, the trial executing a second type process for every multiple executions of a first type process; and
determining the accumulation necessity for each of the plurality of sets of the output data generated by the multiple executions of the first type process in response to an end of conducting the trial the certain number of times.

7. The non-transitory computer-readable recording medium according to claim 1, wherein
the process content includes one or more process contents acquired in one or more paths where the output data are generated in a structure in which the output data generated at a previous stage are input to the process at a following stage among the plurality of processes, and
the data accumulation determination process further includes
calculating a complexity of the process based on an inclusion relation among the plurality of process contents; and
calculating a use expectation value indicating a likelihood of reusing the output data so that the greater the calculated complexity is, the smaller the use expectation value is.

8. The non-transitory computer-readable recording medium according to claim 6, further comprising:
calculating the first cost for accumulating the output data in the repository by using at least an execution time measured by the execution of the process, a reuse time pertinent to reuse of the output data, and the calculated use expectation value;
calculating the second cost for generating the output data that are not accumulated in the repository by using at least the execution time measured by the execution of the process, and the calculated use expectation value; and
determining to accumulate the data in the repository for the first cost that is less than or equal to the second cost.

9. A data accumulation determination method performed by a computer, comprising:
calculating a first cost and a second cost from a process content pertinent to a process for acquiring a final result by a plurality of processes, the process content including a plurality of process contents respective to a plurality sets of output data generated in paths until the final result is acquired by the plurality of processes from subject data, the first cost corresponding to a cost for accumulating the output data in a repository, the second cost corresponding to a cost for generating the output data that are not accumulated in the repository; and
determining an accumulation necessity for each of the plurality of sets of the output data based on the first cost and the second cost.

10. A data accumulation determination apparatus, comprising:
a memory; and
a processor coupled to the memory and the processor configured to
calculate a first cost and a second cost from a process content pertinent to a process for acquiring a final result by a plurality of processes, the process content including a plurality of process contents respective to a plurality sets of output data generated in paths until the final result is acquired by the plurality of processes from subject data, the first cost corresponding to a cost for accumulating the output data in a repository, the second cost corresponding to a cost for generating the output data that are not accumulated in the repository; and
determine an accumulation necessity for each of the plurality of sets of the output data based on the first cost and the second cost.
